(19) United States
(12) Patent Application Publication
(10) Pub. No.: US 2026/0079454 A1
(43) Pub. Date: Mar. 19, 2026

(54) CONTROL PARAMETER ADJUSTMENT DEVICE AND CONTROL PARAMETER ADJUSTMENT METHOD

(71) Applicant: Panasonic Intellectual Property Management Co., Ltd., Osaka (JP)

(72) Inventors: Shun TAKAYANAGI, Osaka (JP); Taichi SHIMIZU, Osaka (JP); Naganori SHIRAKATA, Osaka (JP); Takayuki TSUKIZAWA, Osaka (JP)

(21) Appl. No.: 19/109,488

(22) PCT Filed: May 31, 2023
(86) PCT No.: PCT/JP2023/020297

§ 371 Date: Mar. 6, 2025

(30) Foreign Application Priority Data
Sep. 28, 2022 (JP) 2022-155094

(51) Int. Cl. G05B 13/02

(52) U.S. Cl. CPC G05B 13/024

(57) ABSTRACT

A control parameter adjustment device includes: an actual process operation information obtainer that obtains actual process operation information indicating an operation to be performed by an equipment item in actual process workflow; an adjustment operation command generator that generates, based on the actual process operation information, an adjustment operation command of a plurality of control parameters which specifies an operation to be performed by a servomotor; a controller that controls the servomotor based on the adjustment operation command and the plurality of control parameters; a state information obtainer that obtains state information pertaining to a state of the equipment item which results from the operation performed by the servomotor under control of the controller; and a control parameter adjuster that adjusts the plurality of control parameters based on the state information.

### TECHNICAL FIELD

The present disclosure relates to a control parameter adjustment device that adjusts control parameters of a servomotor.

### BACKGROUND ART

Patent Literature (PTL) 1 discloses a control parameter adjustment device that adjusts control parameters of a servomotor included in an equipment item.

### CITATION LIST

### Patent Literature

[PTL 1] Japanese Unexamined Patent Application Publication No. 2020-35159

### SUMMARY OF INVENTION

### Technical Problem

However, PTL 1 does not disclose a specific method of generating an operation command for control parameter adjustment.

For example, an equipment item can use an operation command for a servomotor which is to be used in actual process workflow as an operation command for control parameter adjustment. However, when the servomotor performs a relatively complicated operation in the actual process workflow, control parameter adjustment sometimes does not finish within a practical time frame because the control parameter adjustment takes too much time.

For this reason, when the servomotor performs a relatively complicated operation in actual process workflow, it is necessary to prepare an appropriate operation command for control parameter adjustment to adjust control parameters.

Nevertheless, it is typically difficult for a person who does not have accumulation of know-how about control parameter adjustment to prepare an appropriate operation command for control parameter adjustment when the servomotor performs a relatively complicated operation in actual process workflow.

In view of the above, the present disclosure aims to provide a control parameter adjustment device and a control parameter adjustment method which are capable of adjusting control parameters without preparing an operation command for control parameter adjustment.

### SOLUTION TO PROBLEM

A control parameter adjustment device according to one aspect of the present disclosure is a control parameter adjustment device that adjusts a plurality of control parameters of a servomotor included in an equipment item. The control parameter adjustment device includes: an actual process operation information obtainer that obtains actual process operation information indicating an operation to be performed by the equipment item in actual process workflow; an adjustment operation command generator that generates, based on the actual process operation information, an adjustment operation command of the plurality of control parameters, the adjustment operation command of the plurality of control parameters specifying an operation to be performed by the servomotor; a controller that controls the servomotor based on the adjustment operation command and the plurality of control parameters; a state information obtainer that obtains state information pertaining to a state of the equipment item which results from the operation performed by the servomotor under control of the controller; and a control parameter adjuster that adjusts the plurality of control parameters based on the state information.

A control parameter adjustment method according to one aspect of the present disclosure is a control parameter adjustment method of adjusting a plurality of control parameters of a servomotor included in an equipment item. The control parameter adjustment method includes: obtaining actual process operation information indicating an operation to be performed by the equipment item in actual process workflow; generating, based on the actual process operation information, an adjustment operation command of the plurality of control parameters; controlling the servomotor based on the adjustment operation command and the plurality of control parameters; obtaining state information pertaining to a state of the equipment item which results from an operation performed by the servomotor under control in the controlling; and adjusting the plurality of control parameters based on the adjustment operation command and the state information.

### Advantageous Effects of Invention

A control parameter adjustment device and a control parameter adjustment method according to one aspect of the present disclosure can appropriately adjust control parameters without preparing an operation command for control parameter adjustment.

### BRIEF DESCRIPTION OF DRAWINGS

FIG. 1 is a schematic diagram illustrating an overview of a control parameter adjustment system according to an embodiment.

FIG. 2 is a perspective view of an equipment item according to the embodiment.

FIG. 3 is a schematic diagram illustrating one example of a path taken by a target object to be driven in an actual process workflow of the equipment item according to the embodiment.

FIG. 4 is a schematic diagram illustrating one example of a plurality of unit operations divided by first operation command generator 21 according to the embodiment.

FIG. 5 shows one example of a plurality of unit operation frequency characteristics calculated by a feature calculator according to the embodiment.

FIG. 6 is a schematic diagram illustrating one example of a state in which a second operation command generator according to the embodiment specifies one or more specific unit frequency characteristics.

FIG. 7 is a schematic diagram illustrating one example of a state in which the second operation command generator according to the embodiment checks whether a difference between a natural frequency indicated by a first unit frequency characteristic and a natural frequency indicated by a second unit frequency characteristic is less than a given second threshold.

FIG. 8 is a schematic diagram for explaining a settling time.

FIG. 9 is a flowchart of control parameter adjustment processing.

### DESCRIPTION OF EMBODIMENTS

### Circumstances Leading to One Aspect of the Present Disclosure

The inventors have been working on the development of a control parameter adjustment device that adjusts a plurality of control parameters of a servomotor included in an equipment item.

As described above, in order to appropriately adjust a plurality of control parameters when a servomotor performs a relatively complicated operation in actual process workflow, it is necessary to prepare an appropriate operation command for control parameter adjustment. Meanwhile, although it is necessary to prepare an appropriate operation command for control parameter adjustment in such a case as described above, it is difficult for a person who does not have accumulation of know-how about control parameter adjustment to prepare an appropriate operation command for control parameter adjustment.

In view of the above, the inventors have conducted in-depth experiments and studies over and over to make a control parameter adjustment device that can adjust a plurality of control parameters without preparation of an operation command for control parameter adjustment.

As a result, the inventors have arrived at a control parameter adjustment device and a control parameter adjustment method according to the present disclosure as presented below.

A control parameter adjustment device according to one aspect of the present disclosure is a control parameter adjustment device that adjusts a plurality of control parameters of a servomotor included in an equipment item. The control parameter adjustment device includes: an actual process operation information obtainer that obtains actual process operation information indicating an operation to be performed by the equipment item in actual process workflow; an adjustment operation command generator that generates, based on the actual process operation information, an adjustment operation command of the plurality of control parameters, the adjustment operation command of the plurality of control parameters specifying an operation to be performed by the servomotor; a controller that controls the servomotor based on the adjustment operation command and the plurality of control parameters; a state information obtainer that obtains state information pertaining to a state of the equipment item which results from the operation performed by the servomotor under control of the controller; and a control parameter adjuster that adjusts the plurality of control parameters based on the state information.

According to the control parameter adjustment device configured as described above, the adjustment operation command generator generates an adjustment operation command of a plurality of control parameters based on actual process operation information that indicates an operation to be performed in actual process workflow. Thereafter, the control parameter adjuster adjusts the plurality of control parameters based on the generated adjustment operation command.

Therefore, the control parameter adjustment device configured as described above can adjust a plurality of control parameters without preparation of an operation command for control parameter adjustment.

In addition, when the state information is obtained by the state information obtainer, the adjustment operation command generator may further generate the adjustment operation command based on the state information.

With this, the content of state information can be reflected in an adjustment operation command.

Moreover, the adjustment operation command generator may include: a first operation command generator that (i) divides, into a plurality of unit operations, the operation to be performed by the equipment item which is indicated by the actual process operation information, (ii) generates a plurality of unit operation commands that cause the equipment item to perform the plurality of unit operations and specify the operation to be performed by the servomotor, and (iii) generates a first adjustment operation command including the plurality of unit operation commands; a feature calculator that calculates, when first state information pertaining to the state of the equipment item which results from the operation performed by the servomotor under control of the controller based on the first adjustment operation command is obtained by the state information obtainer, an equipment item feature pertaining to a feature of the equipment item, based on the first state information; and a second operation command generator that selects, based on the equipment item feature, one or more unit operation commands from among the plurality of unit operation commands, and generates a second adjustment operation command including the one or more unit operation commands. The control parameter adjuster may adjust the plurality of control parameters based on the second adjustment operation command as the adjustment operation command.

With this, a plurality of control parameters can be adjusted based on a unit operation command.

In addition, the state information may be displacement information indicating a time series of displacement pertaining to the equipment item. Based on the displacement information, the feature calculator may calculate, as the equipment item feature, a frequency characteristic of the equipment item which pertains to an oscillation of the equipment item.

With this, a plurality of control parameters can be adjusted based on a frequency characteristic of an equipment item.

Moreover, the displacement information may include a plurality of unit displacement information items that are in one-to-one correspondence with the plurality of unit operation commands. Each of the plurality of unit displacement information items may indicate the time series of the displacement of the equipment item which results from the operation performed by the servomotor under control of the controller based on the plurality of unit operation commands corresponding to the plurality of unit displacement information items. Based on the plurality of unit displacement information items, the feature calculator may calculate, as the frequency characteristic, a plurality of unit frequency characteristics that are in one-to-one correspondence with the plurality of unit operation commands. Each of the plurality of unit displacement information items may indicate the frequency characteristic of the equipment item pertaining to the oscillation of the equipment item which results from the operation performed by the servomotor under control of the controller based on each of the plurality of unit operation commands. The plurality of unit operation commands correspond to the plurality of unit frequency characteristics. The second operation command generator may specify, out of the plurality of unit frequency characteristics, one or more specific unit frequency characteristics that satisfy a given condition, and may select one or more specific unit operation commands that are in one-to-one correspondence with the one or more specific unit frequency characteristics as the one or more unit operation commands.

With this, a plurality of control parameters can be adjusted based on a unit operation command that causes an oscillation having a frequency characteristic that satisfies a given condition in an equipment item.

In addition, the second operation command generator may specify the one or more specific unit frequency characteristics on, as the given condition, a condition that an amplitude pertaining to the oscillation of the equipment item which is indicated by a unit frequency characteristic among the plurality of unit frequency characteristics is greater than a given first threshold.

With this, a plurality of control parameters can be adjusted based on a unit operation command that causes an oscillation having an amplitude greater than a first threshold in an equipment item.

Moreover, when (i) there are a first unit frequency characteristic and a second unit frequency characteristic that satisfy the given condition and (ii) a difference between a natural frequency pertaining to the oscillation of the equipment item indicated by the first unit frequency characteristic and a natural frequency pertaining to the oscillation of the equipment item indicated by the second unit frequency characteristic is less than a given second threshold, the second operation command generator may exclude one of the first unit frequency characteristic or the second unit frequency characteristic indicating the amplitude smaller than the amplitude indicated by another of the first unit frequency characteristic or the second unit frequency characteristic to specify the one or more specific unit frequency characteristics.

With this, the number of unit operation commands included in a second adjustment operation command can be reduced. This results in a reduction in a time required for control parameter adjustment.

A control parameter adjustment method according to one aspect of the present disclosure is a control parameter adjustment method of adjusting a plurality of control parameters of a servomotor included in an equipment item. The control parameter adjustment method includes: obtaining actual process operation information indicating an operation to be performed by the equipment item in actual process workflow; generating, based on the actual process operation information, an adjustment operation command of the plurality of control parameters; controlling the servomotor based on the adjustment operation command and the plurality of control parameters; obtaining state information pertaining to a state of the equipment item which results from an operation performed by the servomotor under control in the controlling; and adjusting the plurality of control parameters based on the adjustment operation command and the state information.

According to the above-described control parameter adjustment method, in the generating of an adjustment operation command, an adjustment operation command of a plurality of control parameters is generated based on actual process operation information that indicates an operation to be performed in actual process workflow. Thereafter, in the adjusting of the plurality of control parameters, the plurality of control parameters are adjusted based on the generated adjustment operation command.

Therefore, the above-described control parameter adjustment method can adjust a plurality of control parameters without preparation of an operation command for control parameter adjustment.

In addition, in the generating, when the state information is obtained in the obtaining, the adjustment operation command may be further generated based on the state information.

With this, the content of state information can be reflected in an adjustment operation command.

Hereinafter, a specific example of a control parameter adjustment system according to one aspect of the present disclosure will be described with reference to the drawings. Embodiments presented here are all specific examples of the present disclosure. Accordingly, values, shapes, elements, the arrangement and connection of the elements, steps (processes), orders of the steps, etc., indicated in the embodiments below are mere examples, and thus are not intended to limit the present disclosure. In addition, the drawings are schematic diagrams, and do not necessarily provide strictly accurate illustrations. Throughout the drawings, the same numeral is given to substantially the same element, and redundant description is omitted or simplified.

### Embodiment

### Configuration

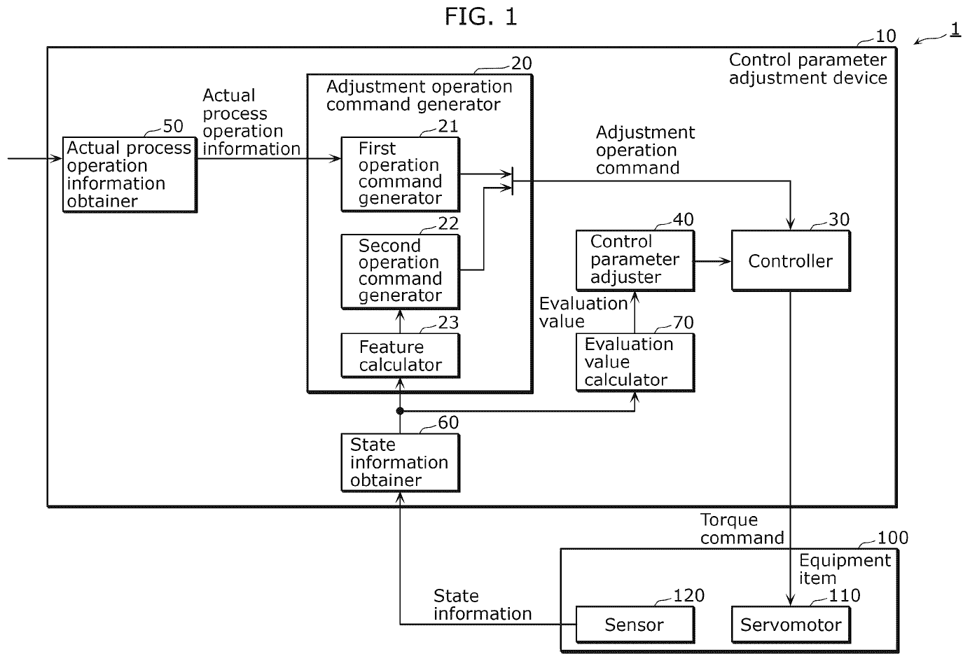

FIG. 1 is a block diagram illustrating a configuration of control parameter adjustment system 1 according to an embodiment.

As illustrated in FIG. 1, control parameter adjustment system 1 includes control parameter adjustment device 10 and equipment item 100.

Equipment item 100 is, for example, a device used for producing apparatuses. Equipment item 100, for example, processes apparatuses, mounts components on the apparatuses, and transports the apparatuses. Equipment item 100 is provided in, for example, a production line in a factory. To be more specific, equipment item 100 is, for example, a light emitting diode (LED) bonder, a mounting machine, a processing machine, or a take-out robot.

Equipment item 100 includes one or more servomotors 110 and sensor 120.

Servomotor 110 performs an operation under control of controller 30 included in control parameter adjustment device 10 to drive a target object to be driven. Controller 30 will be described later in the embodiment. Servomotor 110 receives, for example, a torque command that specifies an operation to be performed by servomotor 110 from controller 30, and drives the target object to be driven according to the received torque command. The target object to be driven is, for example, an object to be processed, an object to be mounted, or an object to be transported in equipment item 100.

Servomotor 110 may be, for example, a rotary motor or a linear motor.

Sensor 120 detects a state of equipment item 100, and outputs state information pertaining to the state of equipment item 100. For this reason, when servomotor 110 is controlled by controller 30, sensor 120 outputs state information pertaining to a state of equipment item 100 which results from an operation performed by servomotor 110 under control of controller 30.

For example, sensor 120 is a displacement detector that sequentially detects displacement pertaining to equipment item 100 (e.g., displacement of a specific part of equipment item 100). In this case, sensor 120 outputs, as the state information, displacement information indicating a time series of displacement pertaining to equipment item 100.

Moreover, for example, sensor 120 may be a speed detector that sequentially detects a speed pertaining to equipment item 100 (e.g., a speed of a specific part of equipment item 100). In this case, sensor 120 outputs, as the state information, speed information indicating a time series of speeds pertaining to equipment item 100.

Furthermore, for example, sensor 120 may be an acceleration detector that sequentially detects acceleration pertaining to equipment item 100 (e.g., acceleration of a specific part of equipment item 100). In this case, sensor 120 outputs, as the state information, acceleration information indicating a time series of acceleration pertaining to equipment item 100.

Moreover, for example, sensor 120 may be a sound detector that detects sounds emitted by equipment item 100. In this case, sensor 120 outputs, as the state information, sound information in which detected sounds have been converted into electrical signals.

In addition, for example, sensor 120 may be an encoder that detects a position of servomotor 110. In this case, sensor 120 outputs, as the state information, encode information indicating a time series of encoded values indicating the positions of servomotor 110.

Hereinafter, sensor 120 will be described as a displacement detector that sequentially detects displacement pertaining to equipment item 100. Accordingly, the state information will be described as displacement information indicating a time series of displacement pertaining to equipment item 100.

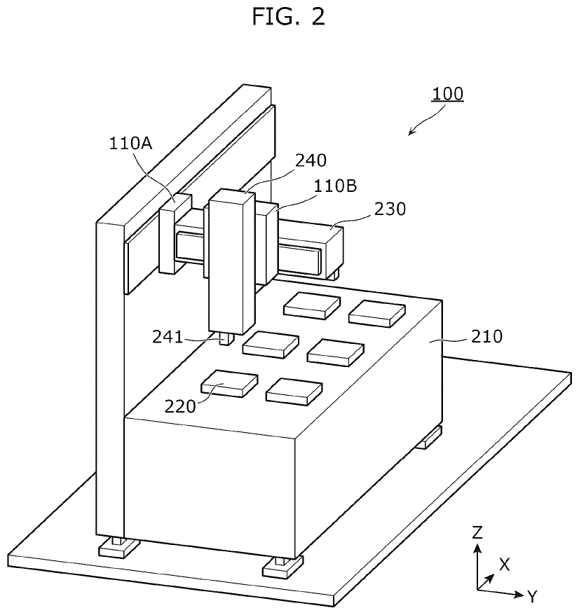

FIG. 2 is a perspective view of one example of equipment item 100 that includes two servomotors 110 and whose target object to be driven is a nozzle fitted to the head.

As illustrated in FIG. 2, equipment item 100 is, as one example, a mounting device that mounts a component on substrate 220 placed on base 210.

As one example, equipment item 100 includes nozzle 241 that is a target object to be driven and sucks a component such that the component adheres to nozzle 241, head 240 to which nozzle 241 is fitted, servomotor 110A that functions as a power source to shift head 240 in the X axis direction in a plan view of base 210, and servomotor 110B that functions as a power source to shift head 240 in the Y axis direction in the plan view of base 210. Here, head 240 is connected to servomotor 110A via arm 230 and servomotor 110B.

Hereupon, reverting to FIG. 1 to continue the description of control parameter adjustment system 1.

Control parameter adjustment device 10 adjusts a plurality of control parameters of servomotor 110 included in equipment item 100.

As illustrated in FIG. 1, control parameter adjustment device 10 includes adjustment operation command generator 20, controller 30, control parameter adjuster 40, actual process operation information obtainer 50, state information obtainer 60, and evaluation value calculator 70.

For example, in a computer device that includes a processor, memory, and various types of interfaces, control parameter adjustment device 10 is implemented by the processor executing a program stored in the memory.

Actual process operation information obtainer 50 obtains actual process operation information indicating an operation to be performed by equipment item 100 in actual process workflow.

For example, as the actual process operation information, actual process operation information obtainer 50 obtains, through a graphical interface, a path, a speed, acceleration, a shift distance, etc. of a target object to be driven in actual process workflow of equipment item 100, from a user who uses control parameter adjustment device 10.

For example, as the actual process operation information, actual process operation information obtainer 50 may also obtain, through a graphical interface, an operation command itself that specifies an operation to be performed by servomotor 110 and is to be used by equipment item 100 in the actual process workflow, from a user who uses control parameter adjustment device 10.

In the present Description, an operation command may be, for example, a position command concerning a position, a speed command concerning a speed, or an acceleration command concerning acceleration.

Controller 30 stores a plurality of control parameters of servomotor 110. In the initial state, controller 30 stores the initial values of the plurality of control parameters, and the stored control parameters are updated by control parameter adjuster 40. Control parameter adjuster 40 will be described later in the embodiment.

The plurality of control parameters include a plurality of parameters, such as a parameter specifying a gain, a parameter specifying a cutoff frequency, and a parameter specifying a filter type, for example.

Upon controller 30 receiving an adjustment operation command of a plurality of control parameters which specifies an operation to be performed by servomotor 110 from adjustment operation command generator 20, controller 30 drives servomotor 110 to cause servomotor 110 to perform the operation specified by the received adjustment operation command, based on the received adjustment operation command and stored control parameters. Note that adjustment operation command generator 20 and the adjustment operation command of a plurality of control parameters will be described later in the embodiment. Here, controller 30 drives servomotor 110 by outputting, to servomotor 110, a torque command specifying an operation to be performed by servomotor 110.

An adjustment operation command that controller 30 receives is either a first adjustment operation command that first operation command generator 21 generates or a second adjustment operation command that second operation command generator 22 generates. First operation command generator 21, the first adjustment operation command, second operation command generator 22, and the second adjustment operation command will be described later in the embodiment.

State information obtainer 60 obtains state information output from sensor 120. The state information pertains to a state of equipment item 100 which results from an operation performed by servomotor 110 under control of controller 30.

Adjustment operation command generator 20 generates, based on actual process operation information obtained by actual process operation information obtainer 50, an adjustment operation command of a plurality of control parameters which specifies an operation to be performed by servomotor 110. When state information is obtained by state information obtainer 60, adjustment operation command generator 20 further generates the adjustment operation command based also on the obtained state information.

As illustrated in FIG. 1, adjustment operation command generator 20 includes first operation command generator 21, second operation command generator 22, and feature calculator 23.

First operation command generator 21 (1) divides, into a plurality of unit operations, an operation to be performed by equipment item 100 which is indicated by actual process operation information, (2) generates a plurality of unit operation commands that specify an operation to be performed by servomotor 110 and cause equipment item 100 to perform the plurality of unit operations, and (3) generates a first adjustment operation command including the generated unit operation commands.

A unit operation is, for example, a relatively simple operation, such as a linear operation. Here, a unit operation is described as a linear operation.

Hereinafter, one example of division of an operation to be performed by equipment item 100 will be described with reference to the drawings. The division is performed by first operation command generator 21, and the operation to be performed by equipment item 100 is indicated by actual process operation information.

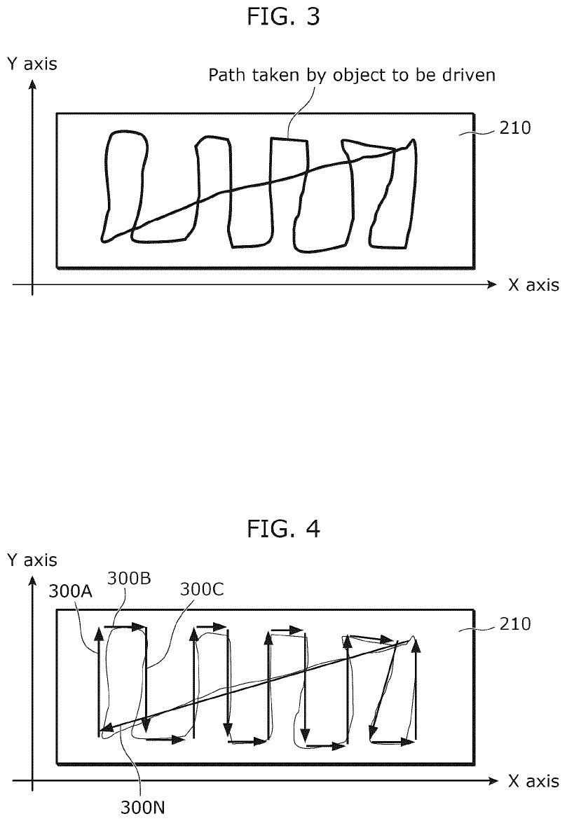

FIG. 3 is a schematic diagram illustrating one example of a path taken by a target object to be driven in an actual process workflow of equipment item 100 and an operation performed by equipment item 100 in the actual process workflow. The operation is indicated by actual process operation information obtained by actual process operation information obtainer 50.

FIG. 4 is a schematic diagram illustrating one example of a plurality of unit operations divided by first operation command generator 21.

As illustrated in FIG. 3 and FIG. 4, first operation command generator 21 divides an operation to be performed by equipment item 100, which is indicated by actual process operation information, into a plurality of unit operations 300 (here, corresponding to unit operation 300A, unit operation 300B, unit operation 300C, unit operation 300N, etc.) that are linear operations, for example.

Hereupon, reverting to FIG. 1 to continue the description of control parameter adjustment system 1.

When state information obtainer 60 obtains first state information pertaining to a state of equipment item 100 which results from an operation performed by servomotor 110 under control of controller 30 based on a first adjustment operation command, feature calculator 23 calculates an equipment item feature pertaining to a feature of equipment item 100 based on the first state information.

As described above, state information here is displacement information. For this reason, feature calculator 23 will be described as calculating, as an equipment item feature, a frequency characteristic of equipment item 100 which pertains to an oscillation of equipment item 100, based on first displacement information that is the first state information.

Meanwhile, when the state information is, for example, sound information indicating a sound emitted by equipment item 100, feature calculator 23 may calculate, as an equipment item feature, a frequency characteristic of the sound emitted by equipment item 100, based on first sound information that is the first state information.

Here, when controller 30 drives servomotor 110 based on a first adjustment operation command generated by first operation command generator 21, state information includes a plurality of unit displacement information items that are in one-to-one correspondence with a plurality of unit operation commands, and each of the plurality of unit displacement information items is information indicating a time series of displacement of equipment item 100 which results from an operation performed by servomotor 110 under control of controller 30 based on the plurality of unit operation commands corresponding to the plurality of unit displacement information items.

For this reason, feature calculator 23 calculates, as a frequency characteristic, a plurality of unit frequency characteristics that are in one-to-one correspondence with the plurality of unit operation commands, based on the plurality of unit displacement information items. Accordingly, each of the plurality of unit frequency characteristics indicates information indicating a frequency characteristic pertaining to an oscillation of equipment item 100 which results from the operation performed by servomotor 110 under control of controller 30 based on the plurality of unit operation commands corresponding to the plurality of unit frequency characteristics.

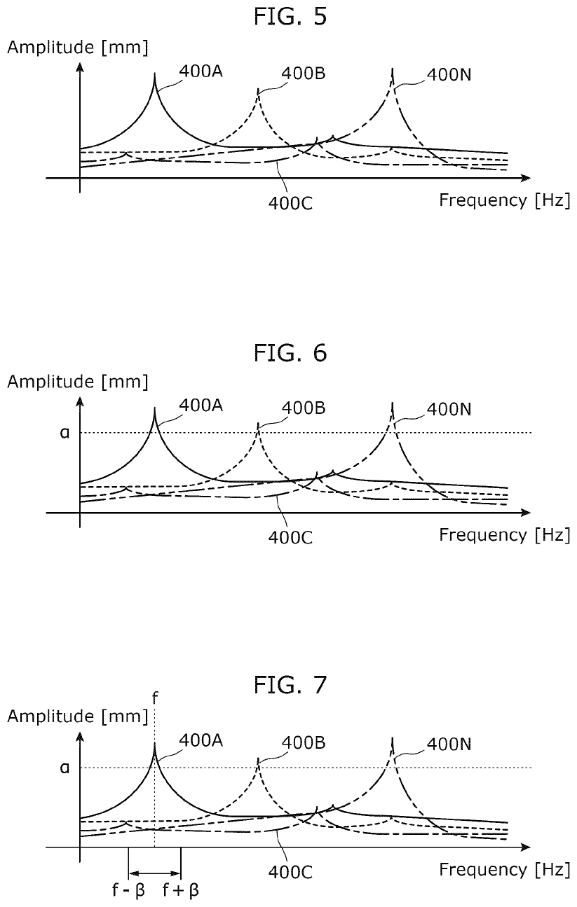

FIG. 5 shows one example of a plurality of unit operation frequency characteristics calculated by feature calculator 23.

In FIG. 5, the horizontal axis represents frequency and the vertical axis represents amplitude. In addition, in FIG. 5, a plurality of unit operation frequency characteristics 400 (here, corresponding to unit operation frequency characteristic 400A, unit operation frequency characteristic 400B, unit operation frequency characteristic 400C, unit operation frequency characteristic 400N, etc.) are in one-to-one correspondence with the plurality of unit operations 300 shown in FIG. 4.

As illustrated in FIG. 5, feature calculator 23 calculates a plurality of unit frequency characteristics that (i) indicate oscillations of equipment item 100 which result from an operation performed by servomotor 110 under control of controller 30 based on a plurality of unit operation commands generated by first operation command generator 21 and (ii) are in one-to-one correspondence with the plurality of unit operation commands.

Hereupon, reverting to FIG. 1 to continue the description of control parameter adjustment system 1.

Based on an equipment item feature, second operation command generator 22 selects one or more unit operation commands from among a plurality of unit operation commands generated by first operation command generator 21, and generates a second adjustment operation command that includes the one or more unit operation commands.

To be more specific, second operation command generator 22 specifies, out of a plurality of unit frequency characteristics calculated by feature calculator 23, one or more specific unit frequency characteristics that satisfy a given condition, and selects, as the one or more unit operation commands, one or more specific unit operation commands that are in one-to-one correspondence with the one or more specific unit frequency characteristics.

Here, a given condition is a condition that an amplitude pertaining to an oscillation of equipment item 100 indicated by a unit frequency characteristic is greater than a given first threshold, for example.

Hereinafter, one example of specification of one or more specific unit frequency characteristics will be described with reference to the drawings. The specification is performed by second operation command generator 22.

FIG. 6 is a schematic diagram illustrating one example of a state in which second operation command generator 22 specifies one or more specific unit frequency characteristics.

In FIG. 6, the horizontal axis represents frequency and the vertical axis represents amplitude.

As illustrated in FIG. 6, second operation command generator 22 specifies, as specific unit frequency characteristics, unit frequency characteristics indicating amplitudes greater than first given threshold a stored in advance. In other words, in the example shown in FIG. 6, second operation command generator 22 specifies unit operation frequency characteristic 400A, unit operation frequency characteristic 400B, and unit operation frequency characteristic 400N as specific unit operation commands.

Here, first given threshold a is set to, for example, a value of an amplitude at which an operation performed by equipment item 100 may suffer inconvenience. With this, second operation command generator 22 can select, as a specific unit operation command, a unit operation command that may cause equipment item 100 to oscillate at an amplitude at which an operation performed by equipment item 100 may suffer inconvenience.

In this case, when (i) there are a first unit frequency characteristic and a second unit frequency characteristic that satisfy a given condition (here, a condition that an amplitude pertaining to an oscillation of equipment item 100 indicated by a unit frequency characteristic is greater than a given first threshold) and (ii) a difference between a natural frequency pertaining to an oscillation of equipment item 100 which is indicated by the first unit frequency characteristic and a natural frequency pertaining to an oscillation of equipment item 100 which is indicated by the second unit frequency characteristic is less than a given second threshold, second operation command generator 22 excludes one of the first unit frequency characteristic or the second unit frequency characteristic indicating the amplitude smaller than the amplitude indicated by another of the first unit frequency characteristic or the second unit frequency characteristic to specify one or more specific unit frequency characteristics.

FIG. 7 is a schematic diagram illustrating one example of a state in which second operation command generator 22 checks whether a difference between a natural frequency indicated by a first unit frequency characteristic and a natural frequency indicated by a second unit frequency characteristic is less than the given second threshold.

In FIG. 7, the horizontal axis represents frequency and the vertical axis represents amplitude.

As illustrated in FIG. 7, second operation command generator 22 calculates natural frequency f for each of unit frequency characteristics indicating an amplitude greater than first given threshold a, and then checks, for each of calculated natural frequencies f, whether another natural frequency falls within the frequency range from a frequency greater than f−β, where given second threshold β is subtracted from a calculated natural frequency f, to a frequency less than f+β, where given second threshold β is added to the calculated natural frequency f. Then, when another natural frequency falls within the frequency range from the frequency greater than f−β to the frequency less than 1+β, second operation command generator 22 excludes a unit frequency characteristic indicating an amplitude smaller than the amplitude indicated by the other unit frequency characteristic to specify a specific unit frequency characteristic.

Here, given second threshold β is set to, for example, a value at which an oscillation indicating a first unit frequency characteristic and an oscillation indicating a second unit frequency characteristic can be taken as oscillations owing to the same or a similar factor. With this, when there are unit operation commands that cause oscillations owing to the same or a similar factor, second operation command generator 22 selects a unit operation command that causes an oscillation of a greater amplitude as one specific unit operation command representing the forgoing unit operation commands, and excludes the remaining unit operation commands of smaller amplitudes from being selected as specific unit operation commands. With this, the number of unit operation commands included in a second adjustment operation command can be reduced.

Hereupon, reverting to FIG. 1 to continue the description of control parameter adjustment system 1.

When state information obtainer 60 obtains second state information pertaining to a state of equipment item 100 which results from an operation performed by servomotor 110 under control of controller 30 based on a second adjustment operation command, evaluation value calculator 70 calculates, based on the second state information, an evaluation value of a plurality of control parameters stored in controller 30.

Here, as one example, state information is described as displacement information indicating displacement of a target object to be driven relative to a target position, and evaluation value calculator 70 is described as calculating, as an evaluation value, a settling time for each of one or more unit operation commands included in a second adjustment operation command.

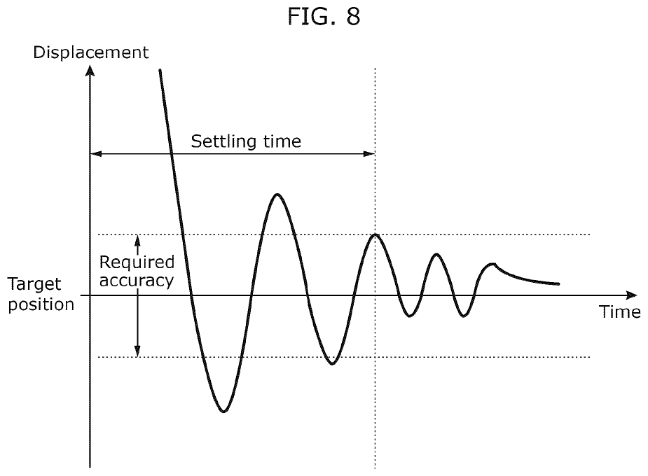

FIG. 8 is a schematic diagram for explaining a settling time.

In FIG. 8, the horizontal axis represents a time elapsed since a unit operation command was initiated, and the vertical axis represents displacement of a target object to be driven relative to a target position which is detected by sensor 120.

As illustrated in FIG. 8, here, a settling time is a time period from a time at which a unit operation command was initiated to a time at which the position of a target object to be driven is settled within required accuracy set using a target position as a reference.

Hereupon, reverting to FIG. 1 to continue the description of control parameter adjustment system 1.

Control parameter adjuster 40 adjusts a plurality of control parameters based on state information. To be more specific, control parameter adjuster 40 adjusts the plurality of control parameters based on settling times calculated by evaluation value calculator 70.

Control parameter adjuster 40 may adjust the plurality of control parameters by, for example, repeatedly updating the plurality of control parameters stored in controller 30 until all of settling times calculated by evaluation value calculator 70 satisfy a given condition (e.g., until all of the settling times fall below a given time) and may cause controller 30 to drive servomotor 110 based on a second adjustment operation command and the updated control parameters. In this case, control parameter adjuster 40 may be an element including a machine learning model that is pretrained to update a plurality of control parameters stored in controller 30 when settling times are input such that the settling times are further reduced.

### Operation

Hereinafter, an operation performed by control parameter adjustment system 1 configured as described above will be described.

Control parameter adjustment system 1 performs control parameter adjustment processing that adjusts a plurality of control parameters of servomotor 110 stored in controller 30. The control parameter adjustment processing is initiated by a user who uses control parameter adjustment system 1 performing an operation on control parameter adjustment device 10 to initiate the control parameter adjustment processing.

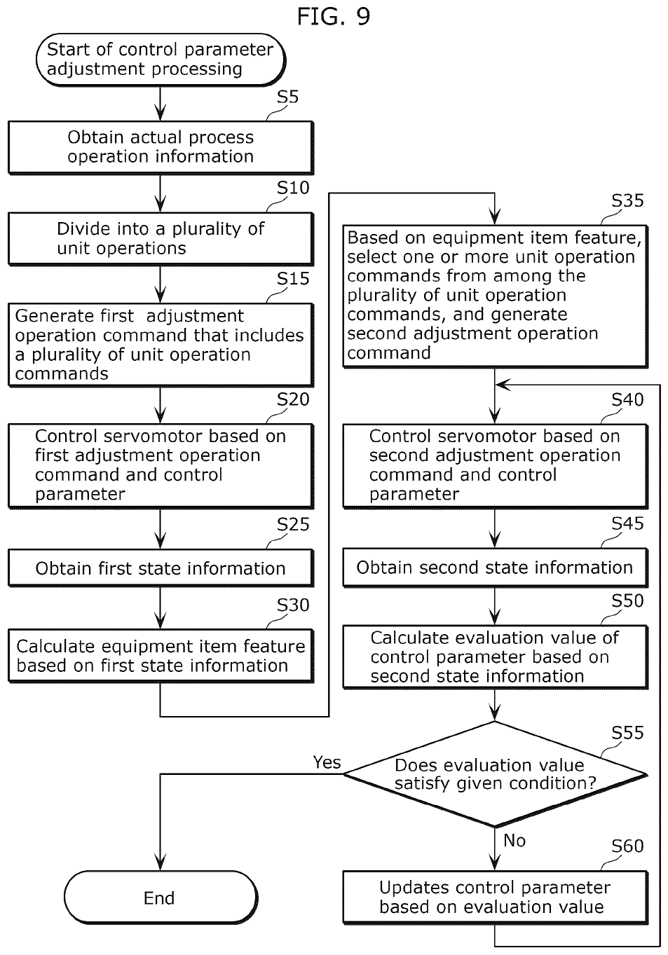

FIG. 9 is a flowchart of control parameter adjustment processing.

As illustrated in FIG. 9, when control parameter adjustment processing is initiated, actual process operation information obtainer 50 obtains actual process operation information indicating an operation to be performed by equipment item 100 in actual process workflow (step S5).

When the actual process operation information is obtained, first operation command generator 21 divides, into a plurality of unit operations, the operation to be performed by equipment item 100 which is indicated by the actual process operation information (step S10).

Thereafter, first operation command generator 21 generates a plurality of unit operation commands that specify an operation to be performed by servomotor 110 and cause equipment item 100 to perform the plurality of unit operations, and generates a first adjustment operation command that includes the plurality of unit operation commands that have been generated (step S15).

When the first adjustment operation command is generated, controller 30 controls servomotor 110 based on the generated first adjustment operation command and a plurality of control parameters stored in controller 30 (step S20). Each of the plurality of control parameters stored in controller 30 at this time point is a value before the value is adjusted through the control parameter adjustment processing, and is, for example, the initial value of the control parameter.

When servomotor 110 is controlled by controller 30 based on the first adjustment operation command, sensor 120 detects a state of equipment item 100 resulting from the operation performed by servomotor 110 under control of controller 30. Thereafter, sensor 120 outputs state information pertaining to the detected state of equipment item 100. Then, state information obtainer 60 obtains first state information pertaining to the state of equipment item 100 resulting from the operation performed by servomotor 110 under control of controller 30 based on the first adjustment operation command (step S25).

When the first state information is obtained, feature calculator 23 calculates an equipment item feature pertaining to a feature of equipment item 100 based on the first state information (step S30).

When the equipment item feature is calculated, second operation command generator 22 selects, based on the equipment item feature, one or more unit operation commands from among the plurality of unit operation commands generated by first operation command generator 21, and generates a second adjustment operation command that includes the one or more unit operation commands (step S35). It should be noted that the first adjustment operation command can be adopted as is for this second adjustment operation command.

When the second adjustment operation command is generated, controller 30 controls servomotor 110 based on the generated second adjustment operation command and the plurality of control parameters stored in controller 30 (step S40).

When servomotor 110 is controlled by controller 30 based on the second adjustment operation command, sensor 120 detects a state of equipment item 100 resulting from an operation performed by servomotor 110 under control of controller 30. Thereafter, sensor 120 outputs state information pertaining to the detected state of equipment item 100. Then, state information obtainer 60 obtains second state information pertaining to the state of equipment item 100 resulting from the operation performed by servomotor 110 under control of controller 30 based on the second adjustment operation command (step S45).

When the second state information is obtained, evaluation value calculator 70 calculates an evaluation value of the plurality of control parameters stored in controller 30 based on the second state information (step S50).

When the evaluation value is calculated, control parameter adjuster 40 determines whether the calculated evaluation value satisfies a given condition (step S55).

When it is determined that the evaluation value does not satisfy the given condition in the process of step S55 (No in step S55), control parameter adjuster 40 updates the plurality of control parameters stored in controller 30 based on the evaluation value (step S60).

After the process of step S60 completes, the processing proceeds to the process of step S40.

When it is determined that the evaluation value satisfies the given condition in the process of step S55 (Yes in step S55), control parameter adjustment device 10 ends this control parameter adjustment processing.

### Study

As has been described above, according to control parameter adjustment device 10 configured as described above, adjustment operation command generator 20 generates an adjustment operation command of a plurality of control parameters based on actual process operation information indicating an operation to be performed in actual process workflow. Thereafter, control parameter adjuster 40 adjusts the plurality of control parameters based on the generated adjustment operation command.

Therefore, control parameter adjustment device 10 configured as described above can adjust a plurality of control parameters without preparation of an operation command for control parameter adjustment.

Moreover, according to control parameter adjustment device 10 configured as described above, an adjustment operation command of a plurality of control parameters is based on an operation performed in actual process workflow as has been described above.

Therefore, according to control parameter adjustment device 10 configured as described above, a risk of not achieving desired performance is reduced in an operation performed by equipment item 100 in actual process workflow using adjusted control parameters.

### Supplementary Information

As has been described above, techniques disclosed by the present application have been described based on the embodiment as examples of the techniques disclosed by the present application. However, the present disclosure is not limited to the above-described embodiment. One or more aspects of the present disclosure also encompass: embodiments achieved by applying various modifications conceivable to those skilled in the art to the present embodiment; and embodiments achieved by optionally combining the elements in different embodiments or variations, as long as these embodiments do not depart from the spirit of the present disclosure.

(1) In the embodiment, adjustment operation command generator 20 is described as including first operation command generator 21 that generates a first adjustment operation command, second operation command generator 22 that generates a second adjustment operation command, and feature calculator 23 that calculates a feature. However, adjustment operation command generator 20 need not always be limited to the above-described configuration as long as adjustment operation command generator 20 can generate an adjustment operation command based on actual process operation information and can further generate the adjustment operation command based also on obtained state information when the state information is obtained by the state information obtainer.

As another example of the configuration, adjustment operation command generator 20 may include, for example, a machine learning model pretrained to generate a first adjustment operation command based on actual process operation information and to further generate a second adjustment operation command based also on obtained state information when the state information is obtained by the state information obtainer.

(2) The generic or specific aspects of the present disclosure may be implemented by a system, a device, a method, an integrated circuit, a program, or a non-transitory recording medium, such as a computer-readable CD-ROM. Moreover, the generic or specific aspects of the present disclosure may be implemented by an optional combination of the system, the device, the method, the integrated circuit, the program, and the non-transitory recording medium. For example, the present disclosure may be implemented as a program for causing a computer device to execute processes to be performed by the control parameter adjustment device.

### Industrial Applicability

The present disclosure can be widely used by, for example, devices that adjust control parameters.

### Reference Signs List

1 control parameter adjustment system
10 control parameter adjustment device
20 adjustment operation command generator
21 first operation command generator
22 second operation command generator
23 feature calculator
30 controller
40 control parameter adjuster
50 actual process operation information obtainer
60 state information obtainer
70 evaluation value calculator
100 equipment item
110, 110A, 110B servomotor
120 sensor
210 base
220 substrate
230 arm
240 head
241 nozzle
300, 300A, 300B, 300C, 300N unit operation
400, 400A, 400B, 400C, 400N unit operation frequency characteristic

1. A control parameter adjustment device that adjusts a plurality of control parameters of a servomotor included in an equipment item, the control parameter adjustment device comprising:
an actual process operation information obtainer that obtains actual process operation information indicating an operation to be performed by the equipment item in actual process workflow;
an adjustment operation command generator that generates, based on the actual process operation information, an adjustment operation command of the plurality of control parameters, the adjustment operation command of the plurality of control parameters specifying an operation to be performed by the servomotor;
a controller that controls the servomotor based on the adjustment operation command and the plurality of control parameters;
a state information obtainer that obtains state information pertaining to a state of the equipment item which results from the operation performed by the servomotor under control of the controller; and
a control parameter adjuster that adjusts the plurality of control parameters based on the state information.

2. The control parameter adjustment device according to claim 1, wherein when the state information is obtained by the state information obtainer, the adjustment operation command generator further generates the adjustment operation command based on the state information.

3. The control parameter adjustment device according to claim 2, wherein
the adjustment operation command generator includes:
a first operation command generator that (i) divides, into a plurality of unit operations, the operation to be performed by the equipment item which is indicated by the actual process operation information, (ii) generates a plurality of unit operation commands that cause the equipment item to perform the plurality of unit operations and specify the operation to be performed by the servomotor, and (iii) generates a first adjustment operation command including the plurality of unit operation commands;
a feature calculator that calculates, when first state information pertaining to the state of the equipment item which results from the operation performed by the servomotor under control of the controller based on the first adjustment operation command is obtained by the state information obtainer, an equipment item feature pertaining to a feature of the equipment item, based on the first state information; and
a second operation command generator that selects, based on the equipment item feature, one or more unit operation commands from among the plurality of unit operation commands, and generates a second adjustment operation command including the one or more unit operation commands, and
the control parameter adjuster adjusts the plurality of control parameters based on the second adjustment operation command as the adjustment operation command.

4. The control parameter adjustment device according to claim 3, wherein
the state information is displacement information indicating a time series of displacement pertaining to the equipment item, and
based on the displacement information, the feature calculator calculates, as the equipment item feature, a frequency characteristic of the equipment item which pertains to an oscillation of the equipment item.

5. The control parameter adjustment device according to claim 4, wherein
the displacement information includes a plurality of unit displacement information items that are in one-to-one correspondence with the plurality of unit operation commands,
each of the plurality of unit displacement information items indicates the time series of the displacement pertaining to the equipment item which results from the operation performed by the servomotor under control of the controller based on the plurality of unit operation commands corresponding to the plurality of unit displacement information items,
based on the plurality of unit displacement information items, the feature calculator calculates, as the frequency characteristic, a plurality of unit frequency characteristics that are in one-to-one correspondence with the plurality of unit operation commands,
each of the plurality of unit displacement information items indicates the frequency characteristic of the equipment item pertaining to the oscillation of the equipment item which results from the operation performed by the servomotor under control of the controller based on each of the plurality of unit operation commands, the plurality of unit operation commands corresponding to the plurality of unit frequency characteristics, and
the second operation command generator specifies, out of the plurality of unit frequency characteristics, one or more specific unit frequency characteristics that satisfy a given condition, and selects one or more specific unit operation commands that are in one-to-one correspondence with the one or more specific unit frequency characteristics as the one or more unit operation commands.

6. The control parameter adjustment device according to claim 5, wherein
the second operation command generator specifies the one or more specific unit frequency characteristics on, as the given condition, a condition that an amplitude pertaining to the oscillation of the equipment item which is indicated by a unit frequency characteristic is greater than a given first threshold, the unit frequency characteristic being among the plurality of unit frequency characteristics.

7. The control parameter adjustment device according to claim 6, wherein
when (i) there are a first unit frequency characteristic and a second unit frequency characteristic that satisfy the given condition and (ii) a difference between a natural frequency pertaining to the oscillation of the equipment item indicated by the first unit frequency characteristic and a natural frequency pertaining to the oscillation of the equipment item indicated by the second unit frequency characteristic is less than a given second threshold, the second operation command generator excludes one of the first unit frequency characteristic or the second unit frequency characteristic indicating the amplitude smaller than the amplitude indicated by another of the first unit frequency characteristic or the second unit frequency characteristic to specify the one or more specific unit frequency characteristics.

8. A control parameter adjustment method of adjusting a plurality of control parameters of a servomotor included in an equipment item, the control parameter adjustment method comprising:
obtaining actual process operation information indicating an operation to be performed by the equipment item in actual process workflow;
generating, based on the actual process operation information, an adjustment operation command of the plurality of control parameters;
controlling the servomotor based on the adjustment operation command and the plurality of control parameters;
obtaining state information pertaining to a state of the equipment item which results from an operation performed by the servomotor under control in the controlling; and
adjusting the plurality of control parameters based on the adjustment operation command and the state information.

9. The control parameter adjustment method according to claim 8, wherein in the generating, when the state information is obtained in the obtaining, the adjustment operation command is further generated based on the state information.
